(19) United States
(12) Patent Application Publication
(10) Pub. No.: US 2026/0034651 A1
(43) Pub. Date: Feb. 5, 2026

(54) SYSTEMS AND METHODS FOR REMOVING TAPERED BUSHING CONNECTORS FROM TORQUE ROD ASSEMBLIES

(71) Applicant: Tiger Tool International Incorporated, Abbotsford (CA)

(72) Inventors: Michael Andrews, Bellingham, WA (US); Adam Baran, Vancouver (CA)

(73) Assignee: Tiger Tool International Incorporated, Abbotsford, BC (CA)

(21) Appl. No.: 19/203,128

(22) Filed: May 8, 2025

Related U.S. Application Data
(60) Provisional application No. 63/647,537, filed on May 14, 2024.

(51) Int. Cl. B25B 27/06

(52) U.S. Cl. CPC B25B 27/062

(57) ABSTRACT

A torque rod disassembly system for removing a tapered bushing assembly comprising a tapered bushing connector having an internal threaded surface from a structural member defining a tapered opening comprising a housing, a bearing washer, a drive sleeve, a drive nut, and a tension bolt. The housing engages structural member and supports the bearing washer. The drive sleeve threadingly supports the drive nut. The tension bolt extends through the drive sleeve to engage the internal threaded surface of the tapered bushing connector. Rotation of the drive nut displaces the drive sleeve, the tension bolt, and the tapered bushing connector such that the tapered bushing connector is removed from the tapered opening in the structural member.

### RELATED APPLICATIONS

This application (Attorney's Ref. No. P) claims benefit of U.S. Provisional Application Ser. No. 63/647,537 filed May 14, 2024, the contents of which are incorporated herein by reference.

### TECHNICAL FIELD

This invention relates to a bushing removal tool, and, in particular, to a tool for removing tapered bushing connectors from torque rod assemblies.

### BACKGROUND

Certain torque rod assemblies use a tapered bushing assembly to connect first and second structural components of a torque rod assembly. Torque rod assemblies are well known and will be described herein only to that extent helpful to a complete understanding of the present invention.

In particular, certain torque rod assemblies employ a tapered bushing assembly that is press fit into a first opening in a first structural and into a second opening in a second structural member. In this type of torque rod assembly, the second opening is tapered, and the bushing assembly comprises a bushing connector that defines a tapered surface that conforms to the taper of the second opening.

Torque rod assemblies must be maintained and repairs. Torque rod assemblies are designed primarily for function during use and only secondarily for servicing. Accordingly, components of the torque rod assembly are frequently in inaccessible positions, making access to the components for disassembly difficult. Further, torque rod assemblies are subjected to heavy wear in adverse conditions that can increase the difficulty of servicing of the torque rod assembly.

The need thus exists for improved tool systems and methods disassembling torque rod systems for maintenance and repair.

### SUMMARY

The present invention may be embodied as a press tool comprising a base assembly defining a housing guide surface, a drive pin, and a guide sleeve defining a sleeve guide surface. The drive pin engages the base assembly such that axial rotation of the drive pin causes linear displacement of the drive pin relative to the base assembly. The housing guide surface engages the guide sleeve. The sleeve guide surface engages the drive pin.

The present invention may also be embodied as a method of pressing a clevis pin comprising the following steps. A base assembly defining a housing guide surface is provided. A drive pin is provided. A guide sleeve defining a sleeve guide surface is provided. The drive pin is arranged to engage the base assembly such that axial rotation of the drive pin causes linear displacement of the drive pin relative to the base assembly. The guide sleeve is arranged relative to the base assembly such that the housing guide surface engages the guide sleeve. The guide sleeve is arranged relative to the base assembly such that the sleeve guide surface engages the drive pin.

### BRIEF DESCRIPTION OF THE DRAWINGS

FIG. 1 is an exploded view of a portion of a first example torque rod disassembly system of the present invention;

FIG. 2 is a side elevation section view of an example torque rod assembly that may be disassembled using the first example torque rod disassembly system;

FIG. 3 is a side elevation section view illustrating a first stage of a process of using the first example torque rod disassembly system;

FIG. 4 is a side elevation section view illustrating a second stage a process of using the first example torque rod disassembly system;

FIG. 5 is a side elevation section view illustrating a third stage of a process of using the first example torque rod disassembly system;

FIG. 6 is a side elevation section view illustrating a fourth stage of a process of using the first example torque rod disassembly system;

FIG. 7 is a side elevation section view illustrating first example completion stage of a process of using the first example torque rod disassembly system in a first example pulling scenario;

FIG. 8 is a side elevation section view illustrating an alternative pulling scenario that may be encountered when using the first example torque rod disassembly system;

FIG. 9 is a first example transfer bolt that may be used as part of the first example torque rod disassembly system when the alternative pulling scenario depicted in FIG. 8 is encountered;

FIG. 10 is a side elevation section view illustrating an example weldment that may be formed using the example transfer bolt when the example alternative pulling scenario is encountered; and,

FIG. 11 is a side elevation section view illustrating a second example completion stage of the process of using the first example torque rod disassembly system when the example alternative scenario is encountered.

### DETAILED DESCRIPTION

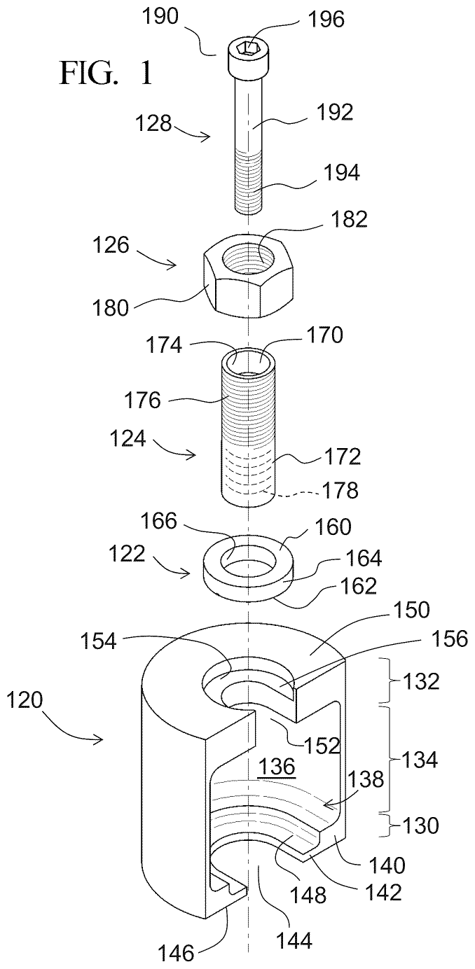

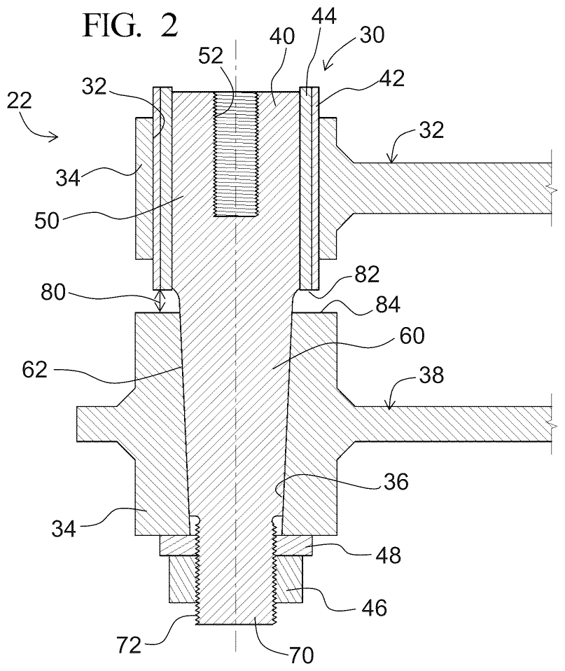

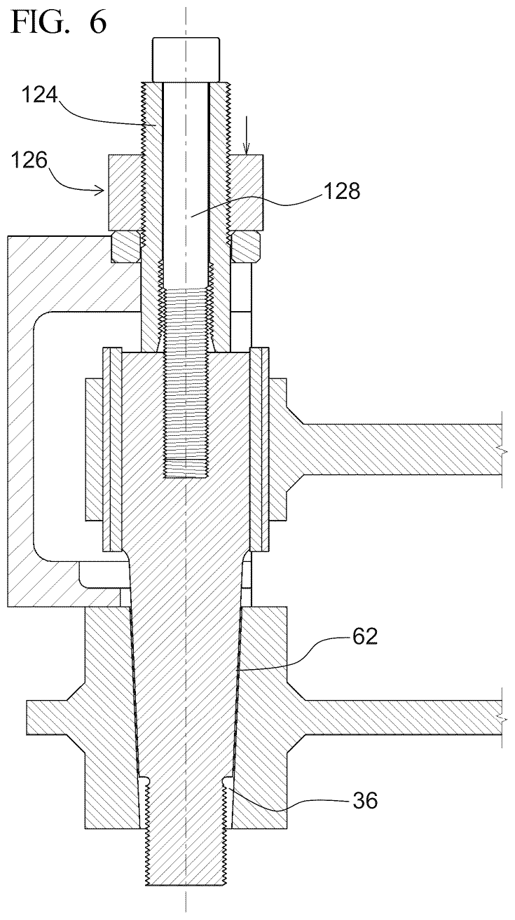

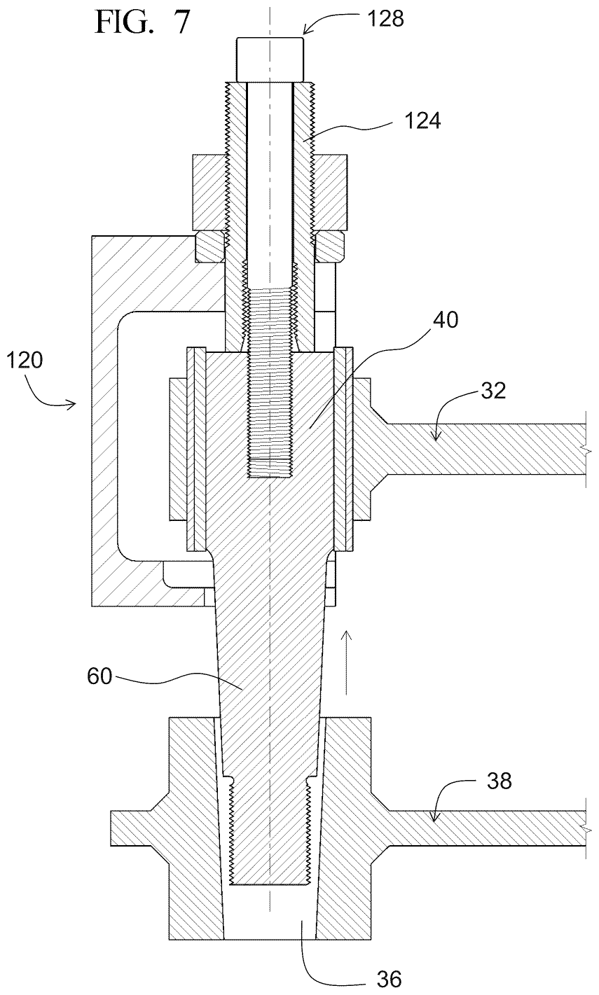

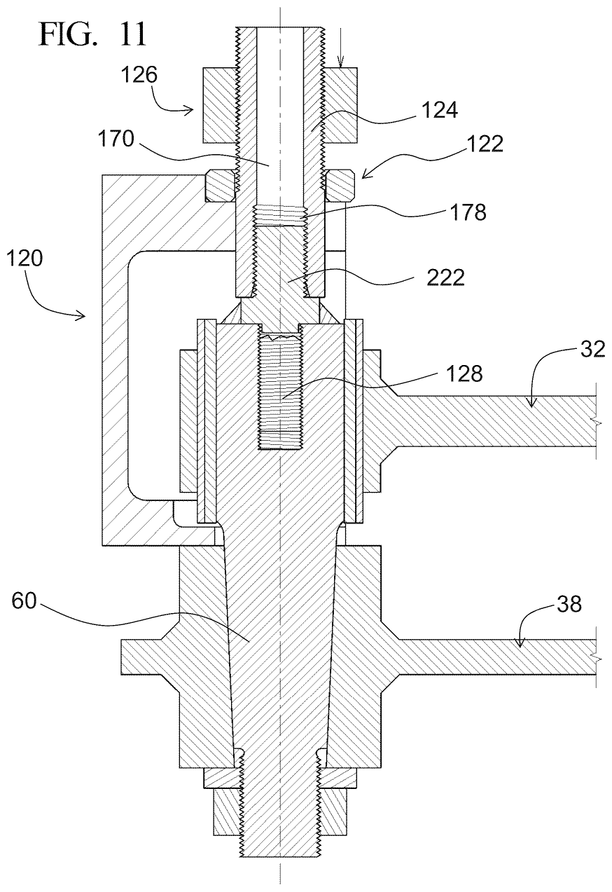

FIGS. 1 and 3-10 of the drawing depict a first example torque rod disassembly system 20 of the present invention. FIGS. 2, 3-8, 10, and 11 depict an example torque rod assembly 22 that may be disassembled using the first example torque rod disassembly system 20. The example torque rod assembly 22 comprises a tapered bushing assembly 30 arranged within a first opening 32 defined by a first structural member 34 and a second opening 36 defined by a second structural member 38. The first example torque rod disassembly system 20 is configured to remove the tapered bushing assembly 30 from the second opening 36.

In particular, in a first scenario the first example torque rod disassembly system 20 is arranged at least partly around the first structural member 34, braced against the second structural member 38, threadingly engaged with the tapered bushing assembly 30, and operated to apply a displacing force on the tapered busing assembly 30 away from the second structural member 38. In a second scenario, a portion of the first example torque rod disassembly system 20 is welded to a portion of the tapered bushing assembly 30 to improve the connection between the first example torque rod disassembly system 20 and the tapered bushing assembly 30 to facilitate application of the displacing force to displace on the tapered busing assembly 30.

With the foregoing general understanding of the construction and use of the present invention in mind, the details of the first example torque rod disassembly system 20 will be described below. The first example torque rod disassembly system 20 may be used with torque rod assemblies other than the example torque rod assembly 22 depicted in the drawing, and the example torque rod assembly 22 does not form any part of the present invention. However, to facilitate an understanding of the construction and operation of the first example torque rod disassembly system 20, the construction of the example torque rod assembly 22 will initially be described.

The tapered bushing assembly 30 of the example torque rod assembly 30 comprises a tapered bushing connector 40, a bushing casing 42, a bushing sleeve 44, a bushing nut 46, and bushing washer 48. The tapered bushing connector 40 comprises a first portion 50 defining an internal threaded surface 52, a second portion 60 defining a tapered surface 62, and a third portion 70 defining an external threaded surface 72. When the example torque rod assembly 22 is assembled, the bushing casing 42 is supported within the first opening 32 defined by the first structural member 38, and the tapered surface 62 of the tapered bushing connector 40 is supported within the second opening 36 in the second structural member 38. With the tapered bushing assembly 30 so supported by the first and second structural members 34 and 38, a gap 80 is formed between a lower edge 82 of the bushing casing 42 and an upper surface 84 of the second structural member 38.

The example torque rod disassembly system 20 comprises a housing 120, a bearing washer 122, a drive sleeve 124, a drive nut 126, and a tension bolt 128.

The example housing 120 defines an anchor portion 130, a drive portion 132, a connecting portion 134, a housing chamber 136, and an access opening 138. A housing axis AH extends through the housing chamber 136. The anchor portion 130 comprises an anchor wall 140 defining an anchor projection 142 and an anchor slot 144. An anchor bearing surface 146 is formed by an outer surface of the anchor wall 140. The example anchor projection 142 extends radially inwardly from the anchor wall 140 towards the housing axis AH. The example anchor wall 140 is thicker than the example anchor projection 142, and an anchor relief surface 148 is contoured to transition between the anchor wall 140 and anchor projection 142. The drive portion 132 comprises a drive wall 150 defining a drive slot 152 and a drive recess 154. A drive bearing surface 156 and drive perimeter surface 158 are formed on the drive wall 150 to define the drive recess 154. The example connecting portion 134 takes the form of a partial cylinder that rigidly connects the anchor portion 130 and the drive portion 132 but is open along at least a portion of the cylinder to define at least a portion of the access opening 138.

The example bearing washer 122 defines a first bearing surface 160, a second bearing surface 162, an outer surface 164, an inner surface 166, and a bearing opening 168.

The example drive sleeve 124 defines a sleeve passageway 170, a sleeve outer surface 172, and a sleeve inner surface 174. A first threaded portion 176 is formed on sleeve outer surface, and a second threaded portion 178 is formed on the sleeve inner surface 174.

The example drive nut 126 defines a nut drive surface 180 and a nut threaded surface 182.

The example tension bolt 128 defines a bolt head 190, a bolt shaft 192, a bolt threaded end 194, and a nut drive surface 196.

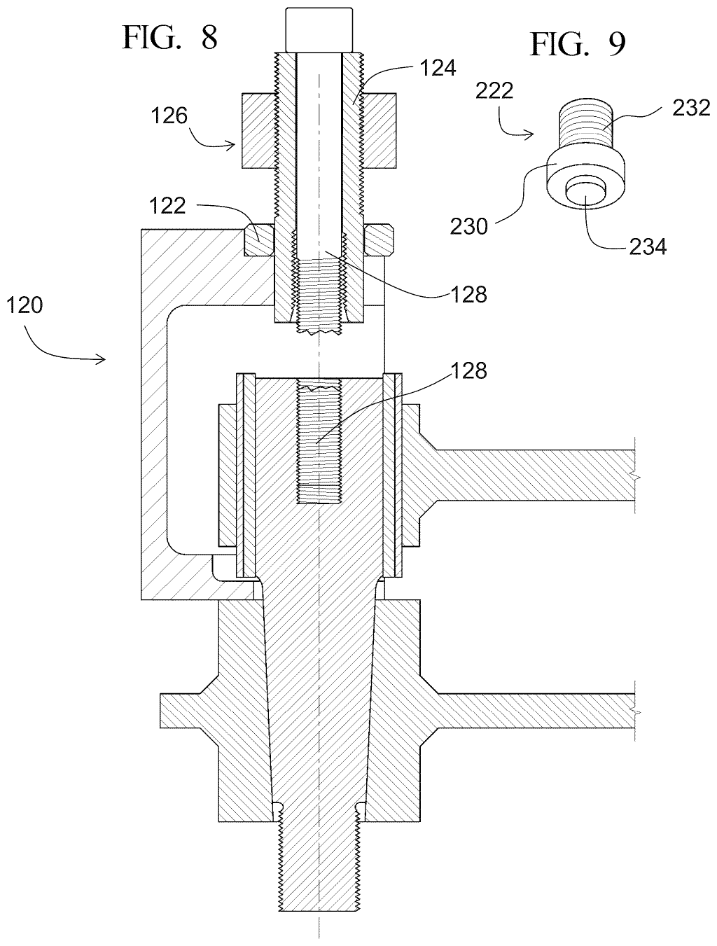

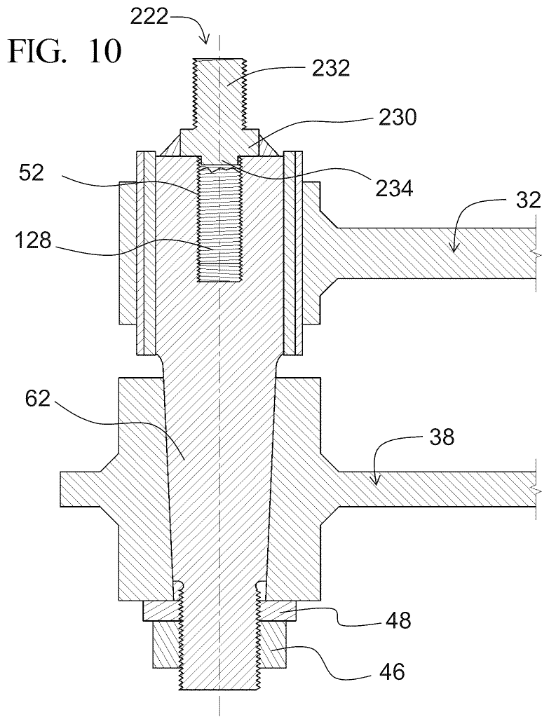

FIGS. 9 and 10 illustrate that the example torque rod disassembly system 20 may further comprise a weldment 220 formed by a transfer bolt 222 and a weld body 224. The example transfer bolt 222 defines a head portion 230, a threaded portion 232, and an aligning extension 234.

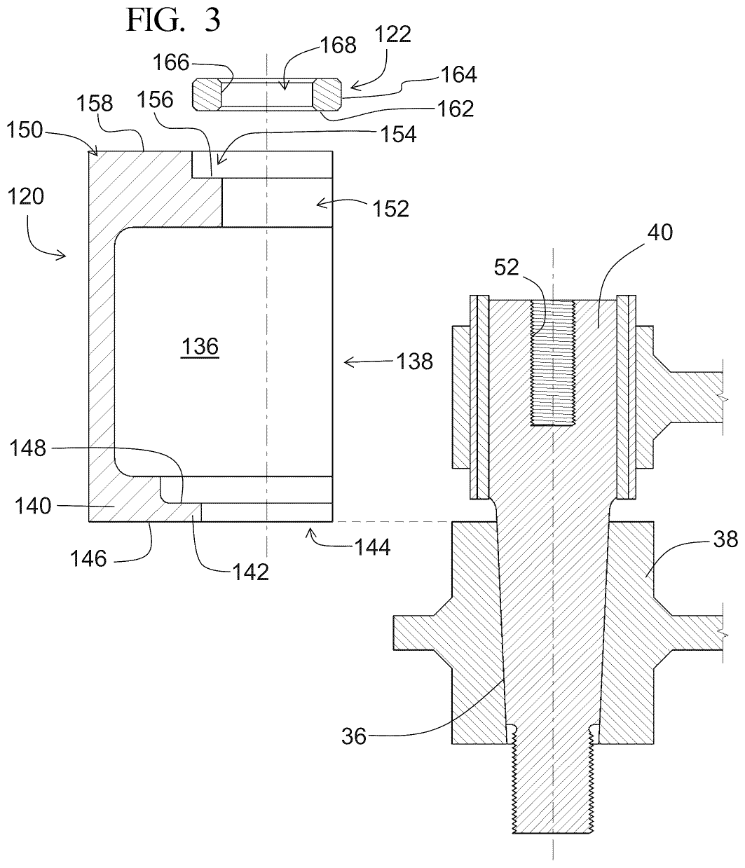

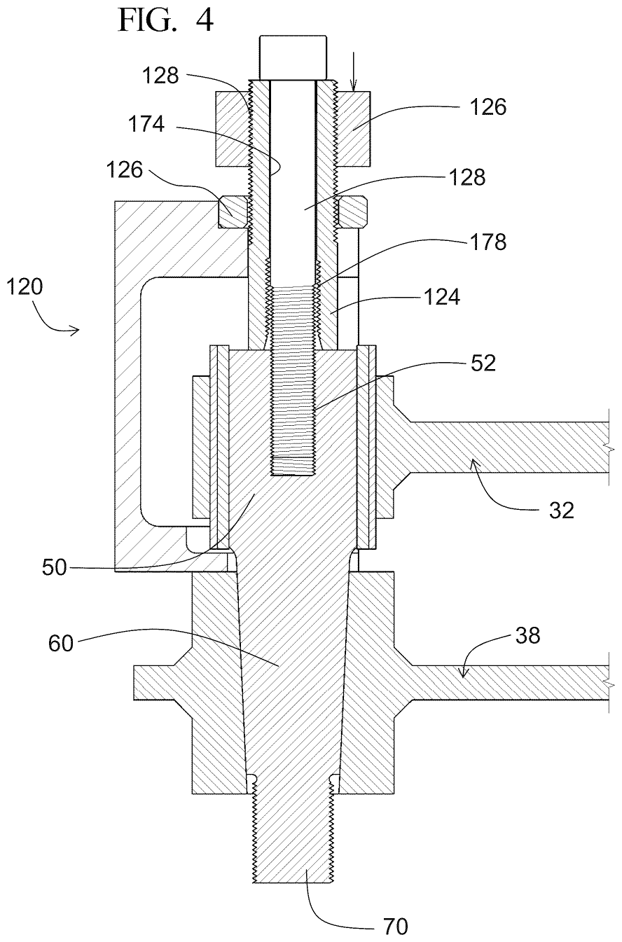

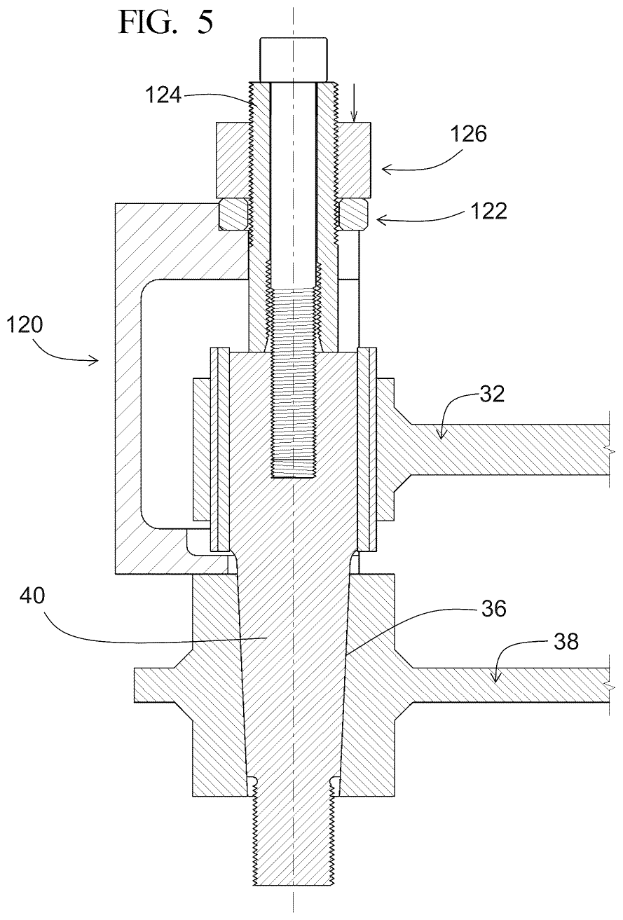

FIGS. 3 and 4 illustrate that the housing 120 is arranged such that the anchor projection 142 is within the gap 80 defined by the torque rod assembly 22 and the anchor projection 142 engages the second structural member 38. Next, as shown in FIG. 4, the drive nut 126 is threadingly supported on the first threaded portion 176 of the drive sleeve 124, the bearing washer 122 is arranged within the drive recess 154, and the tension bolt 128 is inserted through the drive sleeve 124 and the bearing opening 168 of the bearing washer 122 such that the threaded end 194 of the tension bolt 128 engages and is threaded to the internal threaded surface 52 of the tapered bushing connector 40. The drive nut 126 is then axially rotated as shown in FIGS. 4 and 5 until the drive nut 126 engages the bearing washer 122. Further rotation of the drive nut 126 causes the displacing force to force the tapered bushing assembly 30 in a direction away from the second structural member 38 until the tapered bushing connector 40 is removed from the tapered second opening 36 in the second structural member 38.

In some situations, the pulling forces necessary to remove the tapered bushing connector 40 from the tapered second opening 36 exceed the strength of the tension bolt 128, and the tension bolt 128 breaks as illustrated in FIG. 8. In such cases, the transfer bolt 222 is arranged such that the aligning extension 234 thereof is within the internal threaded surface 52 of the tapered bushing connector 40. The weldment 220 is then formed as shown in FIG. 10 by forming the weld body 224 to rigidly connect the transfer bolt 222 to the tapered bushing connector 40. At this point, the tension bolt 128 is removed from the drive sleeve 124, and the second threaded portion 178 formed on the sleeve inner surface 174 is threaded onto the threaded portion 232 of the transfer bolt 222. The drive nut 126 may then be rotated to cause the displacing force to be applied to the tapered bushing connector 40 to displace the drive sleeve 124, transfer bolt 222, and tapered bushing connector 40 away from the second, tapered opening 36 in the second structural member 38 similar to the process depicted in FIGS. 5-7.

What is claimed is:

1. A torque rod disassembly system for removing a tapered bushing assembly comprising a tapered bushing connector having an internal threaded surface from a structural member defining a tapered opening comprising:
a housing;
a drive sleeve;
a drive nut; and
a tension bolt; wherein
the housing engages the structural member;
the drive sleeve threadingly supports the drive nut; and
the tension bolt extends through the drive sleeve to engage the internal threaded surface of the tapered bushing connector; and
rotation of the drive nut applies a displacing force to the drive sleeve, the tension bolt, and the tapered bushing connector such that the displacing force forces the tapered bushing connector in a direction away from the tapered opening in the structural member.

2. The torque rod disassembly system of claim 1, further comprising a bearing washer.

3. The torque rod assembly of claim 2, in which the housing supports the bearing washer.

4. The torque rod assembly of claim 1, in which the drive sleeve is configured to extend at least partly into the housing as the drive nut is rotated.

5. The torque rod assembly of claim 1, in which rotation of drive nut displaces the tapered bushing assembly relative to the housing and the structural member.

6. The torque rod assembly of claim 1, in which the housing comprises an anchor wall defining an anchor bearing surface, wherein the anchor bearing surface engages the structural member.

7. The torque rod assembly of claim 1, further comprising a transfer bolt welded to the tapered bushing connector, where the transfer bolt is configured to engage the drive sleeve such that rotation of the drive nut applies the displacing force to the drive sleeve, the transfer bolt, and the tapered bushing connector such that the displacing force forces the tapered bushing connector in a direction away from the tapered opening in the structural member.

8. A torque rod disassembly system for removing a tapered bushing assembly comprising a tapered bushing connector having an internal threaded surface from a structural member defining a tapered opening comprising:
a housing;
a drive sleeve;
a drive nut; and
a tension bolt; wherein
the housing engages the structural member;
the drive sleeve threadingly supports the drive nut; and
the tension bolt extends through the drive sleeve to engage the internal threaded surface of the tapered bushing connector; and
rotation of the drive nut displaces applies a displacing force to the drive sleeve, the tension bolt, and the tapered bushing such that the displacing force forces the tapered bushing connector in a direction away from the tapered opening.

9. The torque rod disassembly system of claim 8, further comprising a bearing washer.

10. The torque rod assembly of claim 9, in which the housing supports the bearing washer.

11. The torque rod assembly of claim 8, in which the drive sleeve is configured to extend at least partly into the housing as the drive nut is rotated.

12. The torque rod assembly of claim 8, in which rotation of the drive nut displaces the tapered bushing assembly relative to the housing and the structural member.

13. The torque rod assembly of claim 8, in which the housing comprises an anchor wall defining an anchor bearing surface, wherein the anchor bearing surface engages the structural member.

14. The torque rod assembly of claim 8, further comprising a transfer bolt welded to the tapered bushing connector, where the transfer bolt is configured to engage drive sleeve such that rotation of the drive nut applies the displacing force to the drive sleeve, the transfer bolt, and the tapered bushing connector such that the displacing force forces the tapered bushing connector in a direction away from the tapered opening in the structural member.

15. A method for removing a tapered bushing assembly comprising a tapered bushing connector having an internal threaded surface from a structural member defining a tapered opening comprising the steps of:
providing a housing;
providing a drive sleeve;
providing a drive nut;
providing a tension bolt;
arranging the housing to engage the structural member;
arranging the drive sleeve to threadingly support the drive nut; and
arranging the tension bolt to extend through the drive sleeve to engage the internal threaded surface of the tapered bushing connector; and
operating the drive nut to apply a displacement force to the drive sleeve, the tension bolt, and the tapered bushing connector such that the displacing force forces the tapered bushing connector in a direction away from the tapered opening in the structural member.

16. The method as recited in claim 15, further comprises the step of providing a bearing washer.

17. The method as recited in claim 15, further comprising the step of arranging the housing to support the bearing washer.

18. The method as recited in claim 15, further comprising the step of arranging and configuring the drive sleeve to extend at least partly into the housing as the drive nut is operated.

19. The method as recited in claim 15, in which the step of operating the drive nut comprises rotating the drive nut.

20. The method as recited in claim 15, in which the step of providing the housing further comprises the steps of:
providing an anchor wall defining an anchor bearing surface, and
arranging the anchor bearing surface to engage the structural member.

21. The method as recited in claim 15, further comprising the steps of:
providing a transfer bolt configured to engage the drive sleeve;
welding the transfer bolt to the tapered bushing connector; and
rotating the drive nut to apply the displacing force to the drive sleeve, the transfer bolt, and the tapered bushing connector such that the displacing force forces the tapered bushing connector in a direction away from the tapered opening in the structural member.
